(19) United States
(12) Patent Application Publication
(10) Pub. No.: US 2009/0186240 A1
(43) Pub. Date: Jul. 23, 2009

(54) NICKEL COAT CONTAINING PRECIOUS METALS

(75) Inventors: Jürgen Sander, Saarbrücken (DE); Wolfgang Ludt, Kleinblittersdorf (DE)

Correspondence Address: Clements Bernard PLLC, 1901 Roxborough Road, Suite 300, Charlotte, NC, 28211, US

(73) Assignee: NANOGATE AG, Gottelborn (DE)

(21) Appl. No.: 12/299,484

(22) PCT Filed: Apr. 26, 2007
(86) PCT No.: PCT/EP2007/054093

§ 371 Date: Mar. 13, 2009

(30) Foreign Application Priority Data
May 4, 2006 (DE) 10 2006 020 988.5

(51) Int. Cl. C09D 7/00; B05D 3/10; B32B 15/01

(52) U.S. Cl. 428/652; 106/1.19; 106/1.18; 427/305

(57) ABSTRACT

The present invention relates to a chemical nickel bath containing precious metal ions, a process for preparing a chemically deposited nickel coat containing a precious metal, the thus produced nickel coat, and the use thereof.

The present invention relates to a chemical nickel bath containing precious metal ions, a process for preparing a chemically deposited nickel coat containing a precious metal, the thus produced nickel coat, and the use thereof.

Chemically deposited nickel is usually deposited as a wear or corrosion protection coat, usually on metallic materials. The difference from electroplated nickel is mainly the fact that no electric current is used for the deposition. Thus, chemical nickel deposition yields high definition coatings whose layer thickness may typically be within a range of from 8 μm to 80 μm with a tolerance of ±2 μm to ±3 μm. However, from 50 μm, stresses in the coat have to be expected. It is even possible to coat plastic materials, such as polyamide.

Chemically deposited nickel phosphorus coats are known and can be found in many industrial applications: automobile, electronics, printing industries, chemical plant construction, engineering, astronautics, oil and gas industries. The main task of such coats is to protect the substrate from corrosion and wear. The chemically deposited nickel coat can be combined with other coats, such as chrome coats in the printing industry or gold coats as a finish in electronics. However, in contrast to an electroplating process of nickel deposition, the chemical, electroless deposition process is clearly slower. Mostly, from 5 to 15 μm is deposited per hour. For high corrosion protection demands, layers of at least 25 to 30 μm are usually necessary. This results in relatively high costs for the application of such layers, because of nickel raw material on the one hand and because of the long process times of deposition on the other.

To date, it has been possible to increase corrosion protection by a high phosphorus content of a nickel phosphorus coat and by additional coats, such as of chrome or gold. However, in this case, at least one more application step is necessary accordingly.

US 2005/0035843 A1 describes the galvanic electroplating of a nickel-gold alloy having a nickel content of up to 4% by weight.

J. Xu et al. (J. Appl. Phys. 79 (8), Apr. 15, 1996, 3935-3945) describe that nickel and silver are virtually immiscible for high nickel contents. It is only by the special grinding method described that a maximum content of 6.6% by weight of silver in nickel could be achieved.

In addition, there is the so-called “immersion gold/nickel” technology. In this method, a thin gold coat having a layer thickness of typically up to 0.2 μm is deposited on a nickel-phosphorus coat, followed by applying a wear protection coating. This process has the critical drawback that several process steps are necessary for coating, and when the gold layer is broken through by defects, the nickel coat may corrode.

Thus, it is the object of the present invention to provide a chemically deposited nickel coat having an improved corrosion resistance, to provide a process with more favorable process parameters, and thus to open up new application fields and to increase the potential market. It is a further object to avoid the previous problems, such as the unfavorable cost position of the process due to the rather slow chemical nickel deposition and the relatively high layer thickness (application of about 10 μm layer thickness in 1 hour) by using a thinner layer as compared to the prior art and to still provide a chemical deposited nickel coat having similar or improved properties.

In a first embodiment, the object of the invention is achieved by a chemical nickel bath for the electroless deposition of nickel, characterized by having a precious metal ion content within a range of from 0.05 to 5 g/l, a nickel content within a range of from 2 to 20 g/l and a reducing agent content within a range of from 10 to 80 g/l.

The nickel bath according to the invention enables thinner layers to be deposited as compared to the prior art, so that the time needed for depositing the coat can be reduced while a coat having a similar or improved corrosion resistance can be obtained, and thus the process can be rendered more economic. This allows a more flexible application of the process in industrial applications, including in large series, due to the shortened specific process time per coating item. Thus, the nickel bath according to the invention enables a higher throughput per unit time.

The bath according to the invention advantageously essentially consists of an electrolyte usually employed for chemical nickel deposition to which an aqueous solution of, for example, silver methanesulfonate has been added. Alternatively or additionally, a commercially available acidic precious metal electrolyte may also be employed. For the first time, nickel, phosphorus and a precious metal, such as silver, can be simultaneously deposited by chemical deposition with the bath according to the invention. By appropriately selecting the counter ion for the precious metal (silver, for example) and the electrolyte composition, a simultaneous deposition of nickel and silver is enabled.

As mentioned above, to date it has been considered that nickel and, for example, silver are immiscible at a high nickel concentration. To date, coats of these materials have been applied in two separate coats on top of one another. Surprisingly, it has now been found that the materials previously believed to be essentially immiscible can be deposited together in one coat by using the bath according to the invention.

In addition, the coat according to the invention is not sensitive towards corrosion. Surprisingly, there are no local galvanic cells consisting of nickel-phosphorus and precious metal domains, such as silver domains, which would render the coat sensitive towards salt spray testing and acids, but when the bath according to the invention is employed, a coat is obtained in which corrosion protection is even higher as compared to a nickel-phosphorus layer free of precious metal and having a comparable thickness.

Advantageously, the precious metal ions are those of metals selected from the group of silver, gold, platinum, palladium and/or rhodium. Especially for a nickel bath with silver ions, a particularly high corrosion resistance was observed. Silver in an extremely finely divided form is known to act as a bactericide, i.e., weakly toxic, which is attributed to the sufficient formation of soluble silver ions due to the large reactive surfaces. Therefore, the surfaces coated by means of the invention also act in this way and are thus particularly suitable for seawater desalting plants.

Advantageously, the nickel bath has a content of precious metal ions within a range of from 0.1 to 2 g/l, especially within a range of from 0.3 to 0.7 g/l. If the content of precious metal ions is above this range, it may happen that the bath fails to “start”, i.e., does not result in an electroless deposition of nickel.

Advantageously, the precious metal ions have ions of weak acids as counter ions, because too acidic a pH value of the bath, which would slow down the coating process, is thus avoided. In particular, the counter ions are selected from the group of sulfites, sulfonates or phosphonates. The counter ions may preferably have alkyl groups or aryl groups, which in turn may advantageously be partially fluorinated. Even more preferably, the counter ions are trifluoromethanesulfonate, methanesulfonate and/or toluenesulfonate. By appropriately selecting the counter ions, the solubility of the metal ions is increased.

The pH value of the bath according to the invention is advantageously within a range of from 4 to 6, especially within a range of from 4.5 to 5.1. If the pH is lower, the deposition rate of the bath will slow down too much. If the pH is higher, precious metal hydroxide may disadvantageously form.

The nickel ions of the bath according to the invention are advantageously in the form of solutions of the salts nickel chloride, nickel sulfate and/or nickel acetate. The nickel content is advantageously within a range of from 3 to 10 g/l.

The reducing agent is preferably a hypophosphite. Even more preferably, the reducing agent is sodium hypophosphite. The reducing agent is advantageously contained in the bath according to the invention in an amount within a range of from 32 to 42 g/l.

Also advantageously, at least one complexing agent is contained in the bath according to the invention, especially one selected from the group of monocarboxylic acids, dicarboxylic acids, hydroxycarboxylic acids, ammonia and alkanolamines. The complexing agent is advantageously contained in the bath according to the invention in an amount within a range of from 1 to 15 g/l. Complexing agents are advantageous, in particular, because they sequester nickel ions and thus prevent too high concentrations of free nickel ions. This stabilizes the solution and suppresses the precipitation of, for example, nickel phosphite.

Advantageously, at least one accelerator is also contained in the bath according to the invention, especially one selected from the group of anions of mono- and dicarboxylic acids, fluorides and/or borides. The accelerator is advantageously contained in the bath according to the invention in an amount within a range of from 0.001 to 1 g/l. According to the invention, accelerators are advantageous, in particular, because they activate hypophosphite ions, for example, and thus accelerate the deposition.

In usual nickel baths, at least one stabilizer is also contained, especially one selected from the group of lead, tin, arsenic, molybdenum, cadmium, thallium ions and/or thiourea. The stabilizer is advantageously contained in the bath according to the invention in an amount within a range of from 0.01 to 250 mg/l. According to the invention, stabilizers are advantageous, in particular, because they prevent the solution from decomposing by sequestering catalytically active reaction nuclei.

Advantageously, at least one pH buffer agent is also contained in the bath according to the invention, especially a sodium salt of a complexing agent and/or the related corresponding acid. The pH buffer agent is advantageously contained in the bath according to the invention in an amount within a range of from 0.5 to 30 g/l. According to the invention, pH buffer agents are advantageous, in particular, because they can keep the pH constant over extended operation times.

Advantageously, at least one pH control agent is also contained in the bath according to the invention, especially one selected from the group of sulfuric acid, hydrochloric acid, sodium hydroxide, sodium carbonate and/or ammonia. The pH control agent is advantageously contained in the bath according to the invention in an amount within a range of from 1 to 30 g/l. According to the invention, pH control agents are advantageous, in particular, because they can readjust the pH of the bath according to the invention.

Advantageously, at least one wetting agent is also contained in the bath according to the invention, especially one selected from the group of ionogenic and/or non-ionogenic surfactants. The wetting agent is advantageously contained in the bath according to the invention in an amount within a range of from 0.001 to 1 g/l. According to the invention, wetting agents are advantageous, in particular, because they increase the wettability of the surface to be nickel coated with the electrolyte bath.

Advantageously, particles, especially polymer particles, may be dispersed in the nickel bath according to the invention. They advantageously consist of fluoropolymers, even more preferably of tetrafluoropolyethylene. Such particles may advantageously be present in a range of from 1 to 30 g/l. The average particle size is advantageously within a range of from 0.01 to 1 μm. Thus, functional particles in the form of a dispersion may be incorporated in the coat to be prepared according to the invention for further functionalization of the resulting coat: for example, PTFE for minimizing friction, or SiC or other hard materials for increasing the wear protection, with the above mentioned proportions and particle sizes.

In another embodiment, the object of the invention is achieved by a process for preparing a chemically deposited nickel coat in which a nickel bath according to the invention is employed.

The coating process according to the invention is faster than conventional processes since thinner layers as compared to the prior art are necessary with the nickel bath according to the invention for a comparable corrosion protection. In addition, only one process step must be performed for the coating, in contrast to the “immersion gold/nickel” technology.

The surface of the substrate to be coated is advantageously activated or passivated according to need. Activation may advantageously by effected by usual commercially available activators, in the simplest case by half-concentrated hydrochloric acid. The same applies, mutatis mutandis, to passivation.

The process parameters, such as pH and temperature, may advantageously be adapted to the upper limits of conventional bath control. Thus, in the process according to the invention, the temperature is preferably set at least at 85° C., especially at least 88° C. Advantageously, the temperature is at most 95° C.

Advantageously, the process is performed in electroless mode. This can avoid the layer thickness anomaly effect in electrodepositing processes, especially on edges, especially when the production tolerance is particularly difficult.

In a further embodiment, the object of the invention is achieved by a nickel coat on a substrate, characterized in that said nickel coat has a precious metal content of from 1 to 80% by weight and a phosphorus content of from 5 to 20% by weight. To date, it has been considered that certain precious metals, such as silver, are immiscible with nickel for high nickel concentrations. Thus, a nickel coat containing a precious metal could be surprisingly provided according to the invention. In addition, according to the previous opinion, nickel would have to corrode very easily in the presence of a precious metal. Surprisingly, however, no corrosion of nickel occurs in the coats according to the invention.

By the same quality of the coat according to the invention in terms of corrosion resistance as compared to substantially thicker conventional nickel-phosphorus coats, a substantially better production tolerance can be achieved.

Advantageously, the precious metal is contained in the nickel coat according to the invention, with increasing preference, in at least 1, 4, 5, 7 or 10% by weight and independently at most 80, 40, 20 or 12% by weight. Thus, the nickel coat can be designed even more inert as compared to the non-preferred embodiment.

Advantageously, the phosphorus content of the nickel layer according to the invention is within a range of from 5 to 17% by weight, and independently thereof, the nickel content is within a range of from 55 to 90% by weight, especially within a range of from 75 to 90% by weight.

Especially chemically deposited nickel coats with the phosphorus content according to the invention (nickel phosphorus alloy) can be used mainly in functional fields. The layer properties can be controlled through the phosphorus deposited in the coat. According to the invention, a distinction is made between high (from 10 to 14% by weight), medium (from 9 to 12% by weight) and low (from 3 to 7% by weight) phosphorus contents. Preferably, medium phosphorus contents extend from 8 to 9% by weight.

The corrosion-protective effect of the coat is mainly due to a high phosphorus content and the fact that a pore-less coat is deposited, which always depends on the base material and its processing (for example, polishing, grinding, turning, machining). The pretreatment of the material in turn influences the adherence of the coating.

According to the invention, the wear protection increases as the phosphorus content decreases and can advantageously be raised to values of from 800 to 1100 HV (Vickers hardness) by subjecting the coat to a heat treatment at a maximum of 400° C. and a holding time of one hour.

The layer thickness of the nickel coat according to the invention is advantageously at most 100 μm, especially at most 15 μm, even more preferably at most 2 μm and, independently thereof, at least 0.1 μm, especially at least 1 μm. Despite the preferred low maximum layer thickness, an astonishing corrosion-protective effect can surprisingly be achieved with the coat according to the invention.

Advantageously, the ratio of precious metal to nickel in the layer is from 0.5 to 2 times the ratio of precious metal to nickel in the bath, on a molar basis.

Advantageously, particles, especially hard material particles or polymer particles, may also be present in the nickel coat according to the invention. These are advantageously made of fluoropolymers, more preferably tetrafluoropolyethylene (PTFE). Advantageously, such particles may be contained within a range of from 1 to 30% by weight. The average particle size is advantageously within a range of from 0.01 to 1 μm.

Advantageously, the substrate is a conductive substrate, especially a metallic substrate.

The corrosion resistance of the coat according to the invention is extraordinarily high. For example, in a salt-spray test according to DIN 50021, values of above 1000 h can be achieved on, for example, steel (ST 37) for a layer thickness of 15 μm and 7% Ag content. Upon contact with sulfuric acid, the layer according to the invention reacts clearly less and more slowly as compared to a nickel coat, because bright spots will form in contact with sulfuric acid.

The wear resistance of the coat according to the invention is very high.

In another embodiment, the object of the invention is achieved by the use of the nickel coat according to the invention in an application such as antifouling coatings, coatings of surfaces in contact with salt water, especially seawater desalting plants, lubricant coats, corrosion protection coats, readily solderable coats especially for electronics applications, anti-adhesion coats and/or coats having a high electric conductivity.

Particularly advantageous is the use as an antifouling coat in combination with an incorporation of fluoropolymers into the coat, since this renders algal fouling more difficult from the beginning due to reduced adhesion.

The chrome coating of articles is wide-spread. Such chrome coats frequently have cracks, so that the underlying substrate must be effectively protected from corrosion. This is required, in particular, in the paper industry, especially in the printing rolls employed there. By means of the nickel coat according to the invention on a suitable substrate, it is possible to improve the properties of chrome coats applied thereto, since the underlying substrates can be protected from corrosion.

### EXAMPLES

### Example 1

To 2.5 liters of a commercially available nickel-phosphorus electrolyte (Enigma 1613 from Dr. M. Kampschulte GmbH & Co. KG; recommended pH value from 4.2 to 4.8; nickel content about 5.5 g/l; reducing agent content about 40 g/l), 0.1 liter of an aqueous 20% by weight silver methanesulfonate solution was added, and the mixture was agitated and stirred. Another 0.05 liter of the half-way evaporated silver methanesulfonate solution was added. Then, the bath was heated to about 89° C. The pH value was adjusted to about 4.8-5.0 with 0.5 M sulfuric acid and 10% by weight ammonia solution, and deposition began. Through adjusting the temperature, the silver content of the layer obtained could be controlled (higher temperature=lower silver content). In this way, 10 μm was deposited in about 45 min on an aluminum substrate (1 mm, AlMg1) that had previously been activated in the usual way. This resulted in a chemically deposited nickel-phosphorus-silver coat with contents of about 7% by weight silver, 81% by weight nickel and about 12% by weight phosphorus.

The coated aluminum sheet with the 10 μm thick silver-nickel-phosphorus coat according to the invention was exposed to 0.5 M sulfuric acid for 16 hours. The coat showed no corrosion.

### Comparative Example

A coated aluminum sheet analogous to Example 1 with a conventional 10 μm thick nickel-phosphorus coat applied as described above, but without adding silver methanesulfonate, was exposed to 0.5 M sulfuric acid for 16 hours. The coat was destroyed (blister formation, corrosion of aluminum).

### Example 2

To 2.5 liters of a commercially available nickel-phosphorus electrolyte (Enigma 1613 from Dr. M. Kampschulte GmbH & Co. KG; recommended pH value from 4.2 to 4.8; nickel content about 5.5 g/l; reducing agent content about 40 g/l), 0.1 liter of an aqueous acidic gold electrolyte (Auruna 526 from Omicore) was added, and the mixture was agitated and stirred. Then, the bath was heated to about 89° C. The pH value was adjusted to about 4.8-5.0 with 0.5 M sulfuric acid and 10% by weight ammonia solution, and deposition began. Through adjusting the temperature, the gold content of the layer obtained could be controlled (higher temperature=lower gold content). In this way, 10 μm was deposited in about one hour on an aluminum substrate (1 mm, AlMg1) that had previously been activated in the usual way. This resulted in a chemically deposited nickel-phosphorus-gold coat, which can be seen from the pronounced color change of the layer to golden yellow. The corrosion resistance was very good.

### Example 3

To a bath of 1.8 liters according to Example 1, a solution consisting of 25.2 g of PFA dispersion, 0.2 g of FC 135 and 0.9 g of Emulan (OG 40, BASF) was added at 40° C. The solution was heated to about 88° C., and a steel sheet precoated with a chemically deposited nickel coat (5 μm thickness) was immersed therein. After about 45 min, a nickel-silver-phosphorus coat with about 20% fluoropolymer content and about 7% silver in the coat was obtained. The corrosion resistance was very good.

1-11. (canceled)

12. A chemical nickel bath for the electroless deposition of nickel, characterized by having a gold or silver ion content within a range of from 0.05 to 5 g/l, a nickel content within a range of from 2 to 20 g/l and a reducing agent content within a range of from 10 to 80 g/l.

13. The nickel bath according to claim 12, characterized by having a content of gold or silver ions within a range of from 0.1 to 2 g/l, especially within a range of from 0.3 to 0.7 g/l.

14. The nickel bath according to claim 12, characterized in that said gold or silver ions have ions of weak acids as counter ions, the counter ions especially being selected from the group of sulfites, sulfonates or phosphonates.

15. The nickel bath according to claim 12, characterized in that its pH value is within a range of from 4 to 6, especially within a range of from 4.5 to 5.1.

16. A process for preparing a chemically deposited nickel coat in which a nickel bath according to claim 12 is employed.

17. A nickel coat on a substrate, characterized by having a precious metal content of from 1 to 80% by weight and a phosphorus content of from 5 to 20% by weight.

18. The nickel coat according to claim 17, characterized by containing the gold or silver within a range of from 1 to 40% by weight, especially from 4 to 20% by weight.

19. The nickel coat according to claim 17, characterized in that its phosphorus content is within a range of from 5 to 17% by weight, and independently thereof, its nickel content is within a range of from 55 to 90% by weight, especially within a range of from 75 to 90% by weight.

20. The nickel coat according to claim 17, characterized in that its layer thickness is at most 100 μm, especially at most 2 μm, and independently thereof, at least 0.1 μm, especially at least 1 μm.

21. Use of the nickel coat according to claim 17 in an application selected from the group of antifouling coatings, coatings of surfaces in contact with salt water, especially seawater desalting plants, lubricant coats, corrosion protection coats, readily solderable coats especially for electronics applications, anti-adhesion coats and/or coats having a high electric conductivity.
